(19) United States
(12) Patent Application Publication
(10) Pub. No.: US 2014/0347515 A1
(43) Pub. Date: Nov. 27, 2014

(54) IMAGING LENS AND IMAGING DEVICE USING SAME

(71) Applicant: Panasonic Corporation, Kadoma-shi, Osaka (JP)

(72) Inventors: Takumi Iba, Kyoto (JP); Masatoshi Yamashita, Osaka (JP)

(21) Appl. No.: 14/345,297

(22) PCT Filed: Oct. 10, 2012
(86) PCT No.: PCT/JP2012/006471

§ 371 Date: Mar. 17, 2014

(30) Foreign Application Priority Data
Oct. 14, 2011 (JP) 2011-226926

(51) Int. Cl. G02B 13/00; G02B 9/34; G03B 17/56

(52) U.S. Cl. CPC G02B 13/004; G03B 17/565; G02B 9/34
USPC 348/222.1; 359/715

(57) ABSTRACT

An imaging lens includes, arranged in sequence from the object side to the imaging surface side, a first lens having a positive power and convex surfaces on both sides; an aperture diaphragm; a second lens being a meniscus lens having a negative power and a convex surface on the object side; a third lens being a meniscus lens having a positive power and a concave surface on the object side; and a fourth lens having a negative power and concave surfaces on both sides. With this structure, the imaging lens is well corrected for various aberrations in spite of being compact in the lens radial direction and thin in the optical axis direction.

This application is a U.S. National Phase Application of PCT International Application PCT/JP2012/006471.

### TECHNICAL FIELD

The present invention relates to an imaging lens suitable for small mobile products, such as mobile phones, mounted with an imaging device, and also relates to an imaging device including the imaging lens.

### BACKGROUND ART

Small mobile products, such as mobile phones, mounted with an imaging device (a camera module) have been in widespread use in recent years. With these products, users can now easily take pictures.

Various types of imaging lenses have been proposed for use in an imaging device mounted on a small mobile product. Such an imaging lens is of a four-lens design and is compatible with an image pickup device with at least a megapixel resolution (see, for example Patent Literatures 1 through 3).

The imaging lens of Patent Literature 1 includes first to fourth lenses arranged in this order from the object side to the imaging surface side. The first lens has a positive power. The second lens has a negative power. The third lens has a positive or negative power. The fourth lens has a positive or negative power.

The imaging lens of Patent Literature 2 includes first to fourth lenses arranged in this order from the object side to the imaging surface side. The first lens has a positive power. The second lens has a negative power. The third lens has a positive power. The fourth lens has a negative power and an aspheric surface with an inflection point on the object side.

The imaging lens of Patent Literature 3 includes a first lens, an aperture diaphragm, and second to fourth lenses arranged in this order from the object side to the imaging surface side. The first lens has a positive power and a convex surface on the imaging surface side. The second lens has a negative power and a convex surface on the imaging surface side. The third lens has a positive power. The fourth lens has a negative power.

A problem with the imaging lens of Patent Literature 1 is that the fourth lens has a large diameter in comparison to the image size of the optical system, making it difficult to reduce the size of the imaging lens in the lens radial direction. Another problem is as follows. As the diameter of the fourth lens is increased, a lens frame (or a lens tube or a lens barrel) to hold the imaging lens needs to be increased. Therefore, it is difficult to incorporate the lens unit (held in the lens frame or other device), which needs to be small enough to be inserted into the mechanical member, into the mechanical member holding an auto-focus actuator and a lens frame that are widely used nowadays.

One more problem is that when the fourth lens has a large diameter, it is difficult to replace a defective imaging lens because of the following reasons.

In general, the performance of an imaging lens is tested while it is installed in an auto-focus actuator. When the imaging lens consists of small-diameter lenses, the entire lens unit can be replaced and then tested. When having a large-diameter fourth lens, on the other hand, the imaging lens needs to be replaced by disassembling the auto-focus actuator. This is because when the lens unit includes a large-diameter lens, the large lens can be disposed only outside the auto-focus actuator. In this case, the large lens is not moved during the auto focusing, and therefore, it is required to adjust the spacing between the large lens and the lens to be moved by the actuator at the time of lens replacement. Thus, the replacement of the lens unit requires disassembling the auto-focus actuator.

The imaging lenses of Patent Literatures 2 and 3 have similar problems to the imaging lens of Patent Literature 1. Another problem with the imaging lenses of Patent Literatures 2 and 3 is that the optical system has a large overall length (the length from the object-side surface of the first lens to the imaging surface), making it difficult to reduce the size of the imaging lenses in the optical axis direction.

### CITATION LIST

### Patent Literatures

Patent Literature 1: Japanese Unexamined Patent Publication No. 2007-017984
Patent Literature 2: Japanese Unexamined Patent Publication No. 2008-268946
Patent Literature 3: Japanese Unexamined Patent Publication No. 2009-003443

### SUMMARY OF THE INVENTION

To solve the above-described problems, the present invention is directed to provide an imaging lens including, arranged in sequence from the object side to the imaging surface side, a first lens having a positive power and convex surfaces on both sides; an aperture diaphragm; a second lens being a meniscus lens having a negative power and a convex surface on the object side; a third lens being a meniscus lens having a positive power and a concave surface on the object side; and a fourth lens having a negative power and concave surfaces on both sides.

With this structure, the imaging lens is well corrected for various aberrations in spite of being compact in the lens radial direction and thin in the optical axis direction.

The present invention is also directed to provide an imaging device including: an image pickup device for at least converting a light signal corresponding to the subject into an image signal and then outputting the image signal; and the above-described imaging lens for forming an image of the subject on the imaging surface of the image pickup device.

With this structure, the imaging device including the imaging lens can be compact and have high performance, and hence, a mobile product such as a mobile phone including the imaging device can be compact and have high performance.

### BRIEF DESCRIPTION OF DRAWINGS

FIG. 1 is a layout showing the configuration of an imaging lens according to a first exemplary embodiment of the present invention.

FIG. 2A shows the spherical aberration (the axial chromatic aberration) of the imaging lens according to the first exemplary embodiment of the present invention.

FIG. 2B shows the astigmatism of the imaging lens according to the first exemplary embodiment of the present invention.

FIG. 2C shows the distortion aberration of the imaging lens according to the first exemplary embodiment of the present invention.

FIG. 3 is a layout showing the configuration of an imaging lens according to a second exemplary embodiment of the present invention.

FIG. 4A shows the spherical aberration (the axial chromatic aberration) of the imaging lens according to the second exemplary embodiment of the present invention.

FIG. 4B shows the astigmatism of the imaging lens according to the second exemplary embodiment of the present invention.

FIG. 4C shows the distortion aberration of the imaging lens according to the second exemplary embodiment of the present invention.

FIG. 5 is a layout showing the configuration of an imaging lens according to a third exemplary embodiment of the present invention.

FIG. 6A shows the spherical aberration (the axial chromatic aberration) of the imaging lens according to the third exemplary embodiment of the present invention.

FIG. 6B shows the astigmatism of the imaging lens according to the third exemplary embodiment of the present invention.

FIG. 6C shows the distortion aberration of the imaging lens according to the third exemplary embodiment of the present invention.

### DESCRIPTION OF EMBODIMENTS

An imaging lens and an imaging device including the imaging lens according to each of the exemplary embodiments of the present invention will now be described with reference to drawings. Note that the present invention is not limited to these exemplary embodiments.

### First Exemplary Embodiment

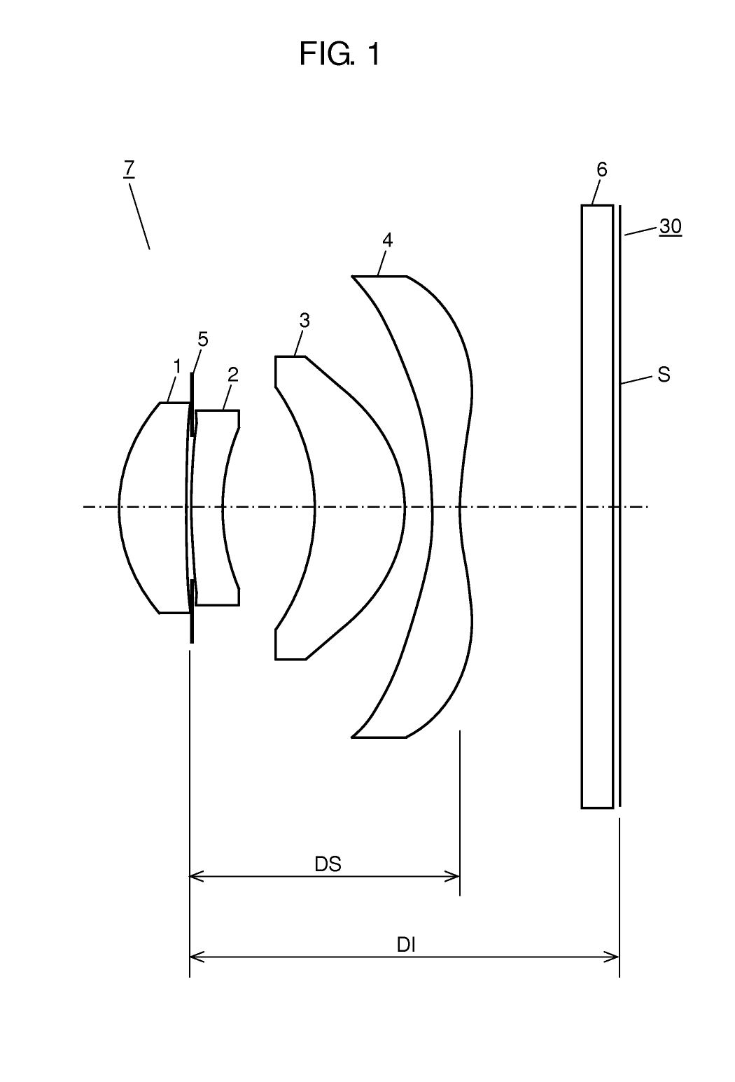

An imaging lens and an imaging device including the imaging lens according to an exemplary embodiment of the present invention will now be described with reference to FIG. 1.

FIG. 1 is a layout showing the configuration of an imaging lens according to the first exemplary embodiment of the present invention.

As shown in FIG. 1, imaging lens 7 of the present exemplary embodiment at least includes first lens 1, aperture diaphragm 5, second lens 2, third lens 3, and fourth lens 4, which are arranged in this order from the object side (the left side in FIG. 1) to the imaging surface side (the right side in FIG. 1). First lens 1 is a biconvex lens having a positive power and both convex surfaces. Second lens 2 is a meniscus lens having a negative power and a convex surface on the object side. Third lens 3 is a meniscus lens having a positive power and a concave surface on the object side. Fourth lens 4 is a biconcave lens having a negative power and both concave surfaces. The term “power” is the amount defined by the reciprocal of the focal length.

Imaging lens 7 includes single focus lenses for capturing images. The single focus lenses form an optical image (form an image of the subject) on the imaging surface S of image pickup device 30 (for example, a CCD). Image pickup device 30 converts the light signal corresponding to the subject into an image signal, and then outputs the image signal.

The imaging device of the present exemplary embodiment at least includes the above-mentioned image pickup device 30 and imaging lens 7 of the present exemplary embodiment.

As shown in FIG. 1, there is generally provided transparent parallel plate 6 between fourth lens 4 and the imaging surface S of image pickup device 30. Parallel plate 6 is a plate having a similar function to a combination of an optical low-pass filter, an IR cut filter, and the faceplate (cover glass) of image pickup device 30.

As will be described in detail below, imaging lens 7 according to the present exemplary embodiment is well corrected for various aberrations in spite of being compact in the lens radial direction and thin in the optical axis direction.

More specifically, first lens 1 is a biconvex lens with both convex surfaces, and second lens 2 is a meniscus lens having a negative power and a convex surface on the object side. With this configuration, imaging lens 7 is compact in the lens radial direction and thin in the optical axis direction, and is particularly effectively corrected for spherical aberration and coma aberration.

Third lens 3 is a meniscus lens having a positive power and a concave surface on the object side, and fourth lens 4 is a biconcave lens having both concave surfaces. With this configuration, imaging lens 7 is compact in the lens radial direction and thin in the optical axis direction, and is particularly effectively corrected for astigmatism and distortion aberration.

Disposing aperture diaphragm 5 between first lens 1 and second lens 2 makes imaging lens 7 more compact in the lens radial direction.

As described above, imaging lens 7 of the present exemplary embodiment is well corrected for aberrations such as spherical aberration, coma aberration, astigmatism, and distortion aberration. As a result, imaging lens 7 can be of a compact four-lens design and be compatible with compact high-resolution image pickup device 30 to be mounted on compact mobile devices such as mobile phones. Image pickup device 30 is, for example, a CCD image sensor or a CMOS image sensor which have high resolution (3 to 16 megapixels) and are composed of fine cells with a pixel pitch of 2 μm or less (for example, 1.75 μm, 1.4 μm, or 1.1 μm).

The following is a detailed description of the positional relationship between the lenses of the imaging lens of the present exemplary embodiment.

In the following description, aside from aperture diaphragm 5, the object-side surface of first lens 1 is referred to as the “first surface”, and the imaging-surface-side surface of first lens 1 is referred to as the “second surface”. Similarly, the object-side surface of second lens 2 is referred to as the “third surface”, and the imaging-surface-side surface of second lens 2 is referred to as the “fourth surface”. The object-side surface of third lens 3 is referred to as the “fifth surface”, and the imaging-surface-side surface of third lens 3 is referred to as the “sixth surface”. The object-side surface of fourth lens 4 is referred to as the “seventh surface”, and the imaging-surface-side surface of fourth lens 4 is referred to as the “eighth surface”. The object-side surface of parallel plate 6 is referred to as the “ninth surface”, and the imaging-surface-side surface of parallel plate 6 is referred to as the “tenth surface”. These terms will also be used in the second and third exemplary embodiments. Note that the above-mentioned lens surfaces may be referred to as “optical surfaces” in the following description.

Imaging lens 7 of the present exemplary embodiment satisfies the formula (1) below:

0.3<DS/f<0.7 (1)

where DS is the distance along the optical axis from the object-side surface of aperture diaphragm 5 to the imaging-surface-side surface of fourth lens 4; and f is the focal length of the whole optical system.

When satisfying the formula (1), imaging lens 7 is compact in the lens radial direction and thin in the optical axis direction, and is also well corrected for various aberrations.

If DS/f is 0.7 or more, the distance along the optical axis is too large from the object-side surface of aperture diaphragm 5 to the imaging-surface-side surface of the final lens (fourth lens 4), and also the effective diameter of the final lens (fourth lens 4) is too large. This makes it difficult to make imaging lens 7 compact (reduced in size and thickness). In addition, an increase in the effective diameter of the final lens (fourth lens 4) results in an increase in the size of a lens frame (or a lens tube or a lens barrel) which holds the lenses. As a result, it is difficult to incorporate the lens unit, which needs to be small enough to be inserted into the mechanical member, into the mechanical member holding a widely-used auto-focus actuator and a widely-used lens frame.

One more problem is that when fourth lens 4 has a large diameter, it is difficult to replace a defective imaging lens 7 because of the following reasons. The performance of imaging lens 7 is tested while it is installed in an auto-focus actuator or other device. As described above, however, when having a larger-diameter fourth lens 4, imaging lens 7 needs to be replaced by disassembling the auto-focus actuator or other device.

If, on the other hand, DS/f is 0.3 or less, it is necessary to dispose thin lenses (namely, the second, third, and fourth lenses) between the aperture diaphragm and the imaging-surface-side surface of the final lens (the fourth lens). This makes it difficult to correct various aberrations and to manufacture the lenses. The reason for this is that in general, it is difficult to manufacture thin lenses by grinding or molding, and also to manufacture an imaging optical system including thin lenses.

Imaging lens 7 of the present exemplary embodiment satisfies the formula (2) below:

0.5<DS/Y′<1.4 (2)

where Y′ is the maximum image height (the distance from the optical axis to the farthest image point from the axis) on the imaging surface.

When satisfying the formula (2), imaging lens 7 is compact in the lens radial direction and thin in the optical axis direction, and is also well corrected for various aberrations.

If DS/Y′ is 1.4 or more, the distance along the optical axis is too large from the object-side surface of aperture diaphragm 5 to the imaging-surface-side surface of the final lens (fourth lens 4), and also the effective diameter of the final lens (fourth lens 4) is too large. This makes it difficult to make imaging lens 7 compact (reduced in size and thickness). In addition, an increase in the effective diameter of the final lens (fourth lens 4) results in an increase in the size of a lens frame (or a lens tube or a lens barrel) which holds the lenses. As a result, it is difficult to incorporate the lens unit into the mechanical member which holds the auto-focus actuator and the lens frame.

One more problem is that when fourth lens 4 has a large diameter, it is difficult to replace a defective imaging lens 7.

If, on the other hand, DS/Y′ is 0.5 or less, it is necessary to dispose thin lenses (namely, second lens 2, third lens 3, and fourth lens 4) between aperture diaphragm 5 and the imaging-surface-side surface of final lens (fourth lens 4). This makes it difficult to correct various aberrations and to manufacture the lenses.

It is preferable that the range in the formula (2) be narrowed as in the formula (2)′ below:

0.5<DS/Y′<1.0 (2)′.

Imaging lens 7 of the present exemplary embodiment satisfies the formula (3) below:

0.8<DI/Y′<1.8 (3)

where DI is the distance along the optical axis from the object-side surface of aperture diaphragm 5 to the imaging surface when parallel plate 6 is converted into an air conversion length.

When satisfying the formula (3), imaging lens 7 is thin in the optical axis direction, and provides satisfactory images.

If DI/Y′ is 1.8 or more, the overall length of the optical system is too large, which is the distance along the optical axis from the object-side surface of first lens 1 to the imaging surface S of image pickup device 30. This makes it difficult to make imaging lens 7 thin in the optical axis direction.

If, on the other hand, DI/Y′ is 0.8 or less, the incident angle of the light beam to image pickup device 30 on the imaging surface is increased. Too large an incident angle of the light beam decreases the amount of light received by the light receiver of image pickup device 30, making it impossible to obtain satisfactory images.

Imaging lens 7 of the present exemplary embodiment satisfies the formulas (4) to (7) below:

0.5<f1/f<0.9 (4)

−1.3<f2/f<−0.7 (5)

0.4<f3/f<0.8 (6)

−1.0<f4/f<−0.4 (7)

where f is the focal length of the whole optical system; f1 is the focal length of first lens 1; f2 is the focal length of second lens 2; f3 is the focal length of third lens 3; and f4 is the focal length of fourth lens 4.

The formula (4) indicates the power balance of the first lens 1 to the whole optical system.

If f1/f is not more than 0.5 or not less than 0.9, it is impossible to well correct coma aberration, spherical aberration, and astigmatism while keeping the overall length of the optical system small (short). This makes it difficult to make imaging lens 7 thin in the optical axis direction. It is also impossible to well correct coma aberration, spherical aberration, and astigmatism while keeping the diameter of first lens 1 small. This makes it difficult to make imaging lens 7 compact in the lens radial direction.

The formula (5) indicates the power balance of second lens 2 to the whole optical system.

If f2/f is not more than −1.3 or not less than −0.7, it is impossible to well correct coma aberration, spherical aberration, and astigmatism while keeping the overall length of the optical system smaller (shorter). This makes it difficult to make imaging lens 7 thin in the optical axis direction. It is also impossible to well correct coma aberration, spherical aberration, and astigmatism while keeping the diameter of second lens 2 small. This makes it difficult to make imaging lens 7 compact in the lens radial direction.

The formula (6) indicates the power balance of third lens 3 to the whole optical system.

If f3/f is not more than 0.4 or not less than 0.8, it is impossible to well correct coma aberration, spherical aberration, and astigmatism while keeping the overall length of the optical system smaller (shorter). This makes it difficult to make imaging lens 7 thin in the optical axis direction. It is also impossible to well correct coma aberration, spherical aberration, and astigmatism while keeping the diameter of third lens 3 small. This makes it difficult to make imaging lens 7 compact in the lens radial direction.

The formula (7) indicates the power balance of fourth lens 4 to the whole optical system.

If f4/f is not more than −1.0 or not less than −0.4, it is impossible to well correct coma aberration, spherical aberration, and astigmatism while keeping the overall length of the optical system small (short). This makes it difficult to make imaging lens 7 thin in the optical axis direction. It is also impossible to well correct coma aberration, spherical aberration, and astigmatism while keeping the diameter of fourth lens 4 small. This makes it difficult to make imaging lens 7 compact in the lens radial direction. In addition, an increase in the effective diameter of the final lens (fourth lens 4) results in an increase in the size of a lens frame (or a lens tube or a lens barrel) which holds the lenses. As a result, it is difficult to incorporate the lens unit into the mechanical member which holds the auto-focus actuator and the lens frame.

One more problem is that when fourth lens 4 has a large diameter, it is difficult to replace a defective imaging lens 7.

As described above, when satisfying the formulas (4) to (7) at the same time, imaging lens 7 is compact in the lens radial direction and thin in the optical axis direction, and is also well corrected for various aberrations.

### Example

Imaging lens 7 of the present exemplary embodiment will now be described in detail below with reference to a specific example.

The specific values indicating the shape and properties of each component of imaging lens 7 of the present example are shown in Table 1 below.

TABLE 1

| | | | | | aperture radius |
|---|---|---|---|---|---|
| | r (mm) | d (mm) | n | v | (mm) |
| first surface | 1.439 | 0.672 | 1.5441 | 56.1 | 0.97 |
| (aspheric) | | | | | |
| second surface | −819.690 | 0.050 | — | — | 0.74 |
| (diffractive aspheric) | | | | | |
| (aperture diaphragm) | ∞. | 0 | — | — | 0.65 |
| third surface | 8.513 | 0.290 | 1.6328 | 23.4 | 0.67 |
| (aspheric) | | | | | |
| fourth surface | 1.933 | 0.894 | — | — | 0.73 |
| (aspheric) | | | | | |
| fifth surface | −2.862 | 0.896 | 1.5441 | 56.1 | 1.13 |
| (aspheric) | | | | | |
| sixth surface | −0.910 | 0.263 | — | — | 1.41 |
| (aspheric) | | | | | |
| seventh surface | −5.200 | 0.280 | 1.5441 | 56.1 | 1.92 |
| (aspheric) | | | | | |
| eighth surface | 1.566 | 1.214 | — | — | 2.15 |
| (aspheric) | | | | | |
| ninth surface (filter) | ∞. | 0.3 | 1.5168 | 64.2 | — |
| tenth surface (filter) | ∞. | 0.04 | | | — |
| (imaging surface) | ∞. | — | — | — | 2.856 |

In Table 1, r (mm) is the radius of curvature of the optical surfaces; d (mm) is the thickness of each of first to fourth lenses 1 to 4 and parallel plate 6 on the optical axis; n is the refractive index of each of first to fourth lenses 1 to 4 and parallel plate 6 for the d line (587.5600 nm); v is the Abbe number of each of first to fourth lenses 1 to 4 and parallel plate 6 for the d line. These symbols are also used in the examples in the second and third exemplary embodiments.

Imaging lens 7 shown in FIG. 1 is formed based on the data shown in Table 1.

It goes without saying that in Table 1, first to fourth lenses 1 to 4 are all aspheric, but do not need to be necessarily so.

The aspheric shapes of the lens surfaces are defined by Mathematical Formula 1 below. This holds true in the examples shown in the second and third exemplary embodiments described later.

$$X = \begin{matrix}\frac{\frac{{Y}^{2}}{{R}_{0}}}{1 + \sqrt{1 - ( κ + 1 ) {( \frac{Y}{{R}_{0}} )}^{2}}} + \\ \begin{matrix}A 4 {Y}^{4} + A 6 {Y}^{6} + A 8 {Y}^{8} + \\ A 10 {Y}^{10} + A 12 {Y}^{12} + A 14 {Y}^{14}\end{matrix}\end{matrix} \qquad Mathematical Formula 1$$

where Y is the height from the optical axis; X is the distance between the tangent plane and the aspheric vertex of the aspheric shape with the height Y from the optical axis; R0 is the radius of curvature of the aspheric vertex; κ is the conic constant; and A4, A6, A8, A10, A12, and A14 are the 4th, 6th, 8th, 10th, 12nd, and 14th aspheric coefficients, respectively.

The aspheric coefficients (including the conic constants) of imaging lens 7 of the present example are shown in Table 2A and Table 2B. In Tables 2A and 2B, “E⁺⁰⁰” indicates “10⁺⁰⁰”, and “E⁻⁰²” indicates “10⁻⁰²”. This holds true in the examples shown in the second and third exemplary embodiments described later.

TABLE 2A

| | first surface | second surface | third surface | fourth surface |
|---|---|---|---|---|
| K | −3.18453E−01 | 0.00000E+00 | 0.00000E+00 | −9.10209E−01 |
| A4 | 1.81954E−02 | 6.09911E−02 | 3.68000E−02 | 5.91151E−02 |
| A6 | 2.47037E−02 | −5.45881E−02 | −4.91489E−02 | 5.16031E−02 |
| A8 | 3.90006E−04 | 7.15578E−02 | 2.11299E−03 | −2.13619E−02 |
| A10 | −3.75349E−02 | 2.40435E−02 | 7.23294E−02 | −9.96432E−02 |
| A12 | 8.66035E−02 | −2.74455E−01 | −2.40860E−01 | 3.53889E−01 |
| A14 | −4.17142E−02 | 2.25725E−01 | 1.10534E−01 | −2.75786E−01 |

TABLE 2B

| | fifth surface | sixth surface | seventh surface | eighth surface |
|---|---|---|---|---|
| K | 2.86658E+00 | −3.80233E+00 | 0.00000E+00 | −1.47534E+01 |
| A4 | −6.47883E−02 | −1.99613E−01 | −7.62518E−02 | −9.75326E−02 |
| A6 | −3.48048E−02 | 1.13751E−01 | 2.97360E−02 | 3.66811E−02 |
| A8 | 4.38609E−02 | −6.07379E−02 | 4.86378E−04 | −1.12954E−02 |
| A10 | −3.65187E−02 | 3.47791E−03 | −2.25645E−03 | 1.92809E−03 |
| A12 | 1.29849E−02 | 1.31121E−02 | 4.05827E−04 | −1.37928E−04 |
| A14 | 5.32491E−03 | −3.83222E−03 | −2.32113E−05 | −2.22419E−06 |

Table 3 below shows the focal length f (mm) of the whole optical system; F-number Fno; the maximum image height Y′; the overall length of the optical system TL (mm) when parallel plate 6 is converted into an air conversion length; and the value of each of formulas (1) to (7) of imaging lens 7 of the present example.

TABLE 3

| | |
|---|---|
| f (mm) | 4.26 |
| Fno | 2.7 |
| Y′ (mm) | 2.856 |
| TL (mm) | 4.90 |
| formula (1) DS/f | 0.62 |
| formula (2) DS/Y′ | 0.92 |
| formula (3) DI/Y′ | 1.43 |
| formula (4) f1/f | 0.62 |
| formula (5) f2/f | −0.94 |
| formula (6) f3/f | 0.49 |
| formula (7) f4/f | −0.51 |

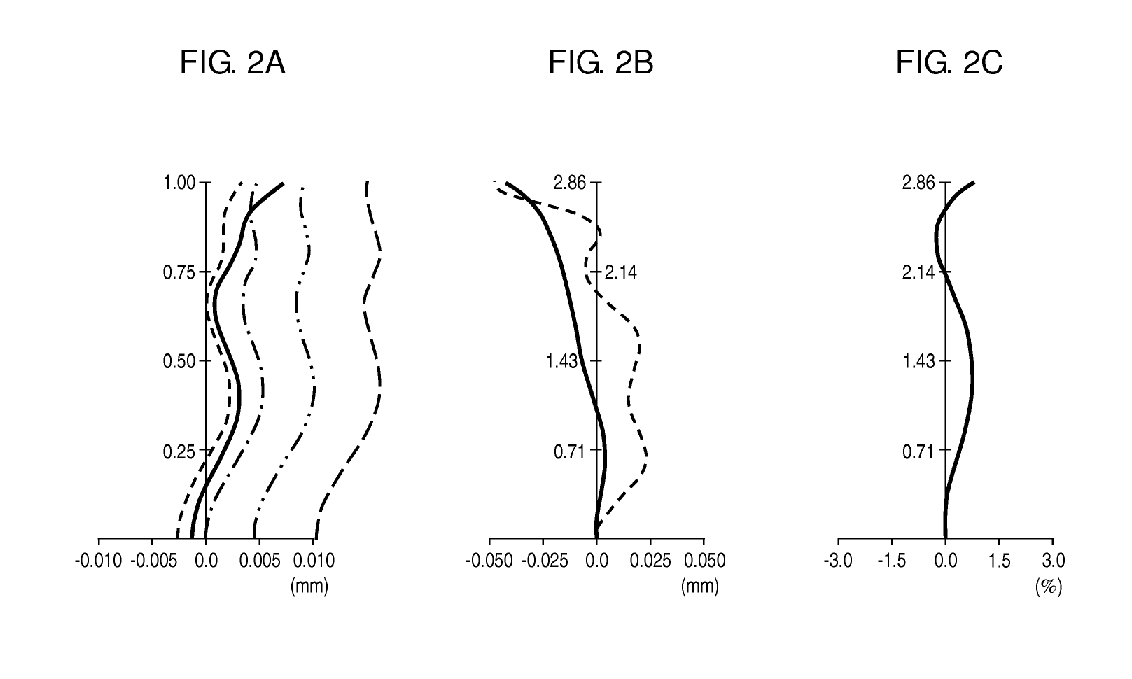

The aberrations of imaging lens 7 of the present example formed based on the above-mentioned dimensions are shown in FIGS. 2A to 2C.

FIG. 2A shows the spherical aberration (the axial chromatic aberration) of the imaging lens according to the first exemplary embodiment of the present invention. In FIG. 2A, the solid line indicates the value of spherical aberration on the g line (435.8300 nm), the long-dashed line on the C line (656.2700 nm), the short-dashed line on the F line (486.1300 nm), the two-dot chain line on the d line (587.5600 nm), and the one-dot chain line on the e line (546.0700 nm).

FIG. 2B shows the astigmatism of the imaging lens according to the present example. In FIG. 2B, the solid line indicates the sagittal image surface curvature and the dashed line indicates the meridional image surface curvature.

FIG. 2C shows the distortion aberration of the imaging lens of the present example.

In FIG. 2C, the axial chromatic aberration is not shown because it is identical to that of FIG. 2A.

As apparent from the aberrations shown in FIGS. 2A to 2C, imaging lens 7 of the present example is well corrected for various aberrations, and can be used in image pickup device 30 with at least a megapixel resolution.

Considering the aberrations shown in FIGS. 2A to 2C and the results shown in Table 3, imaging lens 7 is made compact (reduced in size and thickness), and is also well corrected for various aberrations.

In conclusion, imaging lens 7 of the present example is of a high-performance four-lens design and can be used in image pickup device 30 with at least a megapixel resolution to be mounted on compact mobile products such as mobile phones.

### Second Exemplary Embodiment

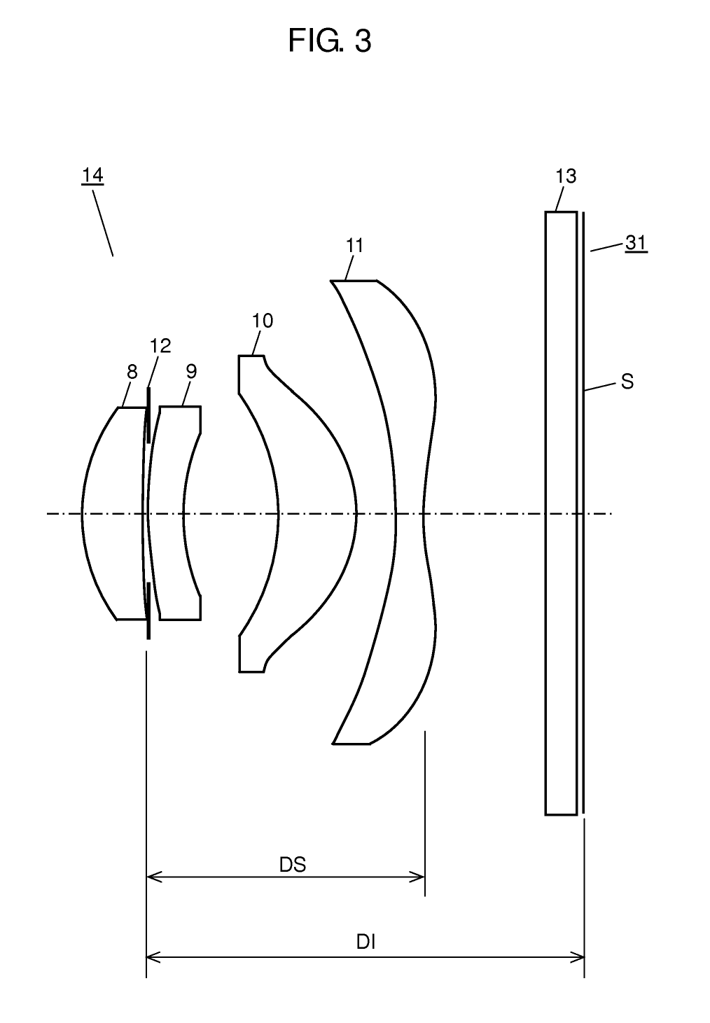

An imaging lens and an imaging device including the imaging lens according to a second exemplary embodiment of the present invention will now be described with reference to FIG. 3.

FIG. 3 is a layout showing the configuration of an imaging lens according to a second exemplary embodiment of the present invention.

The imaging lens and the imaging device including it according to the present exemplary embodiment is basically different from imaging lens 7 and the imaging device including it according to the first exemplary embodiment in including a diffractive optical element on at least one surface of first lens 8 and second lens 9.

As shown in FIG. 3, imaging lens 14 of the present exemplary embodiment at least includes first lens 8, aperture diaphragm 12, second lens 9, third lens 10, and fourth lens 11, which are arranged in this order from the object side (the left side in FIG. 3) to the imaging surface side (the right side in FIG. 3). First lens 8 is a biconvex lens having a positive power and both convex surfaces. Second lens 9 is a meniscus lens having a negative power and a convex surface on the object side. Third lens 10 is a meniscus lens having a positive power and a concave surface on the object side. Fourth lens 11 is a biconcave lens having a negative power and both concave surfaces.

Imaging lens 14 of the present exemplary embodiment includes a diffractive optical element (not shown) on at least one surface of first and second lenses 8 and 9. More specifically, the diffractive optical element is provided on one of the following surfaces: the first and second surfaces of first lens 8 and the third and fourth surfaces of second lens 9. In this configuration, the chromatic aberration of imaging lens 14 and the imaging device can be well corrected by the diffracting action of the diffractive optical element.

Imaging lens 14 includes single focus lenses for capturing images. The single focus lenses form an optical image (form an image of the subject) on the imaging surface S of image pickup device 31 (for example, a CCD). Image pickup device 31 converts the light signal corresponding to the subject into an image signal, and then outputs the image signal.

The imaging device of the present exemplary embodiment at least includes the above-mentioned image pickup device 31 and imaging lens 14 of the present exemplary embodiment.

As shown in FIG. 3, there is provided transparent parallel plate 13 between fourth lens 11 and the imaging surface S of image pickup device 31 in the same manner as parallel plate 6 of the first exemplary embodiment.

The shape of the lens surface provided thereon with the diffractive optical element (hereinafter, the diffractive optical element-provided surface) is obtained, for example, by transforming the shape of the phase function φ (ρ) calculated by Mathematical Formula 2 below. This holds true in the third exemplary embodiment described later.

φ(ρ)=(2π/λ₀)(C2ρ²+C4ρ⁴)

Y=ρ Mathematical Formula 2

where Y is the height from the optical axis; Cn is the n-th phase coefficient (n corresponds to 2 and 4 in C2 and C4 contained in Mathematical Formula 2); and λ₀ is the design wavelength.

It is also preferable that imaging lens 14 of the present exemplary embodiment satisfy the formulas (1) to (7) shown in the first exemplary embodiment.

As a result, imaging lens 14 and the imaging device of the present exemplary embodiment provide similar effects to imaging lens 7 and the imaging device of the first exemplary embodiment.

In the present exemplary embodiment, the diffractive optical element is provided on either first lens 8 or second lens 9, thereby well correcting the chromatic aberration of imaging lens 14 and the imaging device.

### Example

Imaging lens 14 of the present exemplary embodiment will now be described in detail below with reference to a specific example.

The specific values indicating the shape and properties of each component of imaging lens 14 of the present example are shown in Table 4 below. The numerals and symbols contained in Table 4 are not explained here because they have the same meanings as those contained in Table 1 of the first exemplary embodiment.

TABLE 4

| | | | | | aperture radius |
|---|---|---|---|---|---|
| | r (mm) | d (mm) | n | v | (mm) |
| first surface | 1.609 | 0.598 | 1.5441 | 56.1 | 0.94 |
| (aspheric) | | | | | |
| second surface | −47.806 | 0.050 | — | — | 0.74 |
| (diffractive aspheric) | | | | | |
| (aperture diaphragm) | ∞. | 0 | — | — | 0.66 |
| third surface | 4.401 | 0.332 | 1.6328 | 23.4 | 0.67 |
| (aspheric) | | | | | |
| fourth surface | 1.690 | 0.936 | — | — | 0.73 |
| (aspheric) | | | | | |
| fifth surface | −2.481 | 0.791 | 1.5441 | 56.1 | 1.13 |
| (aspheric) | | | | | |
| sixth surface | −0.956 | 0.363 | — | — | 1.35 |
| (aspheric) | | | | | |
| seventh surface | −8.817 | 0.280 | 1.5441 | 56.1 | 1.95 |
| (aspheric) | | | | | |
| eighth surface | 1.668 | 1.210 | — | — | 2.16 |
| (aspheric) | | | | | |
| ninth surface (filter) | ∞. | 0.3 | 1.5168 | 64.2 | — |
| tenth surface (filter) | ∞. | 0.04 | — | — | — |
| (imaging surface) | ∞. | — | — | — | 2.856 |

Imaging lens 14 shown in FIG. 3 is formed based on the data shown in Table 4.

In the present example, as shown in Table 4, the imaging-surface-side surface of first lens 8 (second surface) is a diffractive optical element-provided surface.

The aspheric coefficients (including the conic constants) of imaging lens 14 of the present example are shown in Table 5A and Table 5B below.

TABLE 5A

| | first surface | second surface | third surface | fourth surface |
|---|---|---|---|---|
| K | −5.31591E−01 | 0.00000E+00 | 0.00000E+00 | −1.53576E+00 |
| A4 | 1.16486E−02 | 4.12524E−02 | 1.91215E−02 | 4.73838E−02 |
| A6 | 8.34823E−03 | −7.62668E−02 | −5.53793E−02 | 5.57870E−02 |
| A8 | 1.11756E−03 | 7.40131E−02 | 4.66599E−02 | −7.08552E−02 |
| A10 | −4.07720E−02 | 7.23741E−02 | 9.85064E−02 | 2.07859E−02 |
| A12 | 7.13999E−02 | −2.61150E−01 | −2.22745E−01 | 2.62339E−01 |
| A14 | −3.73661E−02 | 1.90539E−01 | 1.10534E−01 | −2.75786E−01 |

TABLE 5B

| | fifth surface | sixth surface | seventh surface | eighth surface |
|---|---|---|---|---|
| K | 1.16705E+00 | −3.37549E+00 | 0.00000E+00 | −1.31252E+01 |
| A4 | −6.25853E−02 | −1.83789E−01 | −8.31908E−02 | −9.44385E−02 |
| A6 | −4.71459E−02 | 8.88181E−02 | 3.09969E−02 | 3.54193E−02 |
| A8 | 3.39077E−02 | −5.78265E−02 | 4.92044E−04 | −1.05862E−02 |
| A10 | −2.53666E−02 | 6.91898E−03 | −2.36451E−03 | 1.88223E−03 |
| A12 | 3.72878E−02 | 1.38328E−02 | 3.71409E−04 | −1.73641E−04 |
| A14 | −7.75932E−03 | −3.60849E−03 | −1.10694E−05 | 2.59426E−06 |

The specific values of the diffractive optical element-provided surface, which is the imaging-surface-side surface of first lens 8 (second surface), in the present example are shown in Table 6.

TABLE 6

| | second surface |
|---|---|
| design wavelength | 546.07 nm |
| diffraction order | 1 |
| C2 | −1.80000E−03 |
| C4 | −2.00000E−04 |

It goes without saying that as shown in Tables 4, 5A, and 5B, in imaging lens 14 of the present example, first to fourth lenses 8 to 11 are all aspheric, but do not need to be necessarily so.

In imaging lens 14 of the present example, the diffractive optical element is formed on the imaging-surface-side surface of first lens 8 (second surface), but this is not the only option available. More specifically, the diffractive optical element-provided surface can be at least one of the following surfaces: the object-side surface of first lens 8 (first surface), the imaging-surface-side surface of first lens 8 (second surface), the object-side surface of second lens 9 (third surface), and the imaging-surface-side surface of second lens 9 (fourth surface). As a result, similar to the example of the first exemplary embodiment, the chromatic aberration can be well corrected by the diffracting action of the diffractive optical element-provided surface.

Table 7 below shows the focal length f (mm) of the whole optical system; F-number Fno; the maximum image height Y′; the overall length of the optical system TL (mm) when parallel plate 13 is converted into an air conversion length; and the value of each of formulas (1) to (7) of imaging lens 14 of the present example.

TABLE 7

| | |
|---|---|
| f (mm) | 4.22 |
| Fno | 2.8 |
| Y′ (mm) | 2.856 |
| TL (mm) | 4.90 |
| formula (1) DS/f | 0.64 |
| formula (2) DS/Y′ | 0.95 |
| formula (3) DI/Y′ | 1.45 |
| formula (4) f1/f | 0.67 |
| formula (5) f2/f | −1.07 |
| formula (6) f3/f | 0.57 |
| formula (7) f4/f | −0.6 |

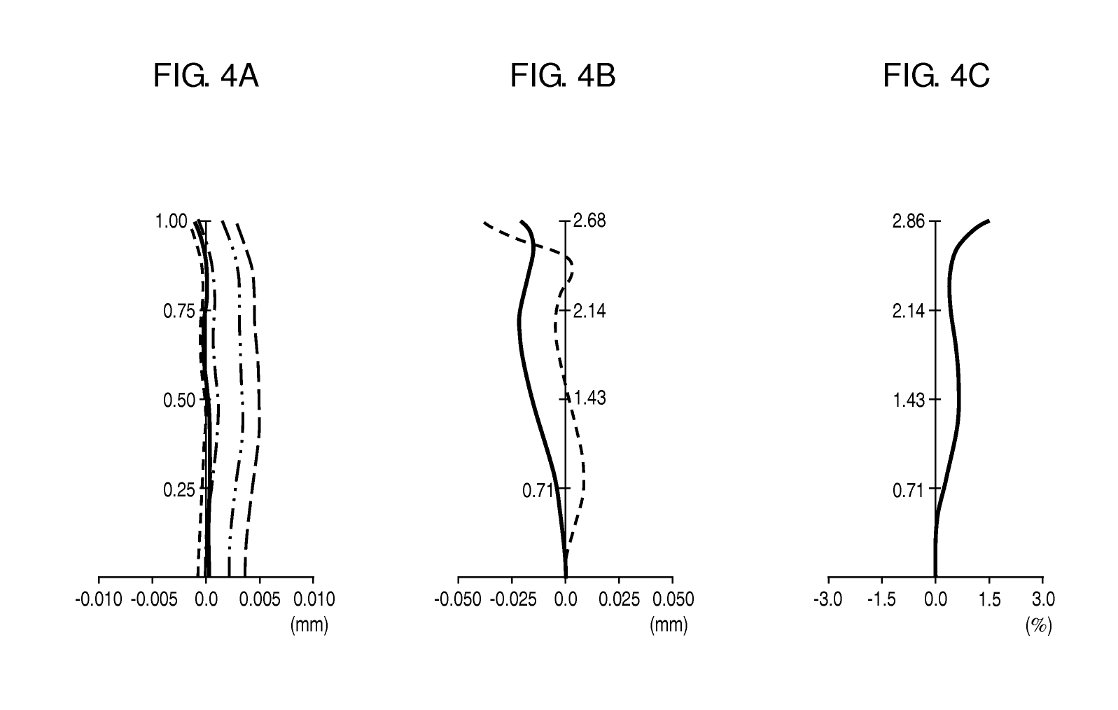

The aberrations of imaging lens 14 of the present example formed based on the above-mentioned dimensions are shown in FIGS. 4A to 4C.

FIG. 4A shows the spherical aberration (the axial chromatic aberration) of the imaging lens according to the second exemplary embodiment of the present invention. In FIG. 4A, the solid line indicates the value of spherical aberration on the g line, the long-dashed line on the C line, the short-dashed line on the F line, the two-dot chain line on the d line, and the one-dot chain line on the e line.

FIG. 4B shows the astigmatism of the imaging lens according to the present example. In FIG. 4B, the solid line indicates the sagittal image surface curvature, and the dashed line indicates the meridional image surface curvature.

FIG. 4C shows the distortion aberration of the imaging lens of the present example.

In FIG. 4C, the axial chromatic aberration is not shown because it is identical to that of FIG. 4A.

As apparent from the aberrations shown in FIGS. 4A to 4C, imaging lens 14 of the present example is well corrected for various aberrations, and can be used in image pickup device 31 with at least a megapixel resolution.

Considering the aberrations shown in FIGS. 4A to 4C and the results shown in Table 7, imaging lens 14 is made compact (reduced in size and thickness), and is also well corrected for various aberrations.

In conclusion, imaging lens 14 of the present example is of a high-performance four-lens design and can be used in image pickup device 31 with at least a megapixel resolution to be mounted on compact mobile products such as mobile phones.

### Third Exemplary Embodiment

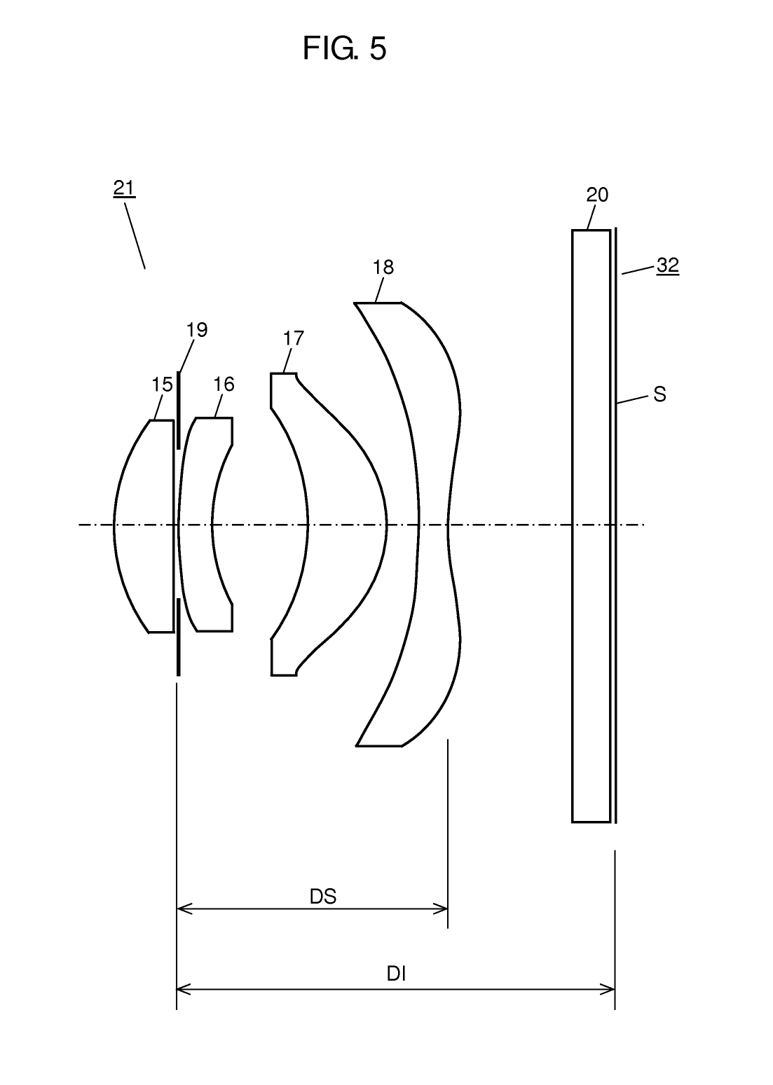

An imaging lens and an imaging device including the imaging lens according to a third exemplary embodiment of the present invention will now be described with reference to FIG. 5. The third exemplary embodiment describes an imaging lens having a different shape from that of the second exemplary embodiment, and also describes an imaging device including the imaging lens.

FIG. 5 is a layout showing the configuration of the imaging lens according to the third exemplary embodiment of the present invention.

As shown in FIG. 5, imaging lens 21 of the present exemplary embodiment at least includes first lens 15, aperture diaphragm 19, second lens 16, third lens 17, and fourth lens 18, which are arranged in this order from the object side (the left side in FIG. 5) to the imaging surface side (the right side in FIG. 5). First lens 15 is a biconvex lens having a positive power and both convex surfaces. Second lens 16 is a meniscus lens having a negative power and a convex surface on the object side. Third lens 17 is a meniscus lens having a positive power and a concave surface on the object side. Fourth lens 18 is a biconcave lens having a negative power and both concave surfaces.

Imaging lens 21 of the present exemplary embodiment includes a diffractive optical element on at least one surface of first and second lenses 15 and 16. In this configuration, the chromatic aberration of imaging lens 21 and the imaging device can be well corrected by the diffracting action of the diffractive optical element.

Imaging lens 21 includes single focus lenses for capturing images. The single focus lenses form an optical image (form an image of the subject) on the imaging surface S of image pickup device 32 (for example, a CCD). Image pickup device 32 converts the light signal corresponding to the subject into an image signal, and then outputs the image signal.

The imaging device of the present exemplary embodiment at least includes the above-mentioned image pickup device 32 and imaging lens 21 of the present exemplary embodiment.

As shown in FIG. 5, there is provided transparent parallel plate 20 between fourth lens 18 and the imaging surface S of image pickup device 32 in the same manner as parallel plate 6 of the first exemplary embodiment.

It is also preferable that imaging lens 21 of the present exemplary embodiment satisfy the formulas (1) to (7) shown in the first exemplary embodiment.

As a result, imaging lens 21 and the imaging device of the present exemplary embodiment provide similar effects to imaging lenses 7 and 14 and the imaging devices of the first and second exemplary embodiments.

In the present exemplary embodiment, the diffractive optical element is provided on either first lens 15 or second lens 16, thereby well correcting the chromatic aberration of imaging lens 21 and the imaging device.

### Example

Imaging lens 21 of the present exemplary embodiment will now be described in detail with reference to a specific example.

The specific values indicating the shape and properties of each component of imaging lens 21 of the present example are shown in Table 8 below. The numerals and symbols contained in Table 8 are not explained here because they have the same meanings as those contained in Table 1 of the first exemplary embodiment.

TABLE 8

| | | | | | aperture radius |
|---|---|---|---|---|---|
| | r (mm) | d (mm) | n | v | (mm) |
| first surface | 1.644 | 0.594 | 1.5441 | 56.1 | 0.98 |
| (aspheric) | | | | | |
| second surface | −129.047 | 0.050 | — | — | 0.78 |
| (diffractive aspheric) | | | | | |
| (aperture diaphragm) | ∞. | 0 | | | 0.7 |
| third surface | 3.745 | 0.334 | 1.6328 | 23.4 | 0.73 |
| (aspheric) | | | | | |
| fourth surface | 1.633 | 0.933 | — | — | 0.78 |
| (aspheric) | | | | | |
| fifth surface | −2.558 | 0.797 | 1.5441 | 56.1 | 1.18 |
| (aspheric) | | | | | |
| sixth surface | −0.949 | 0.312 | — | — | 1.39 |
| (aspheric) | | | | | |
| seventh surface | −11.898 | 0.300 | 1.5441 | 56.1 | 1.92 |
| (aspheric) | | | | | |
| eighth surface | 1.558 | 1.225 | — | — | 2.15 |
| (aspheric) | | | | | |
| ninth surface (filter) | ∞. | 0.4 | 1.5168 | 64.2 | — |
| tenth surface (filter) | ∞. | 0.04 | — | — | — |
| (imaging surface) | ∞. | — | — | — | 2.856 |

Imaging lens 21 shown in FIG. 5 is formed based on the data shown in Table 8.

In the present example, as shown in Table 8, the imaging-surface-side surface of first lens 15 (second surface) is a diffractive optical element-provided surface.

The aspheric coefficients (including the conic constants) of imaging lens 21 of the present example are shown in Table 9A and Table 9B below.

TABLE 9A

| | first surface | second surface | third surface | fourth surface |
|---|---|---|---|---|
| K | −5.62851E−01 | 0.00000E+00 | 0.00000E+00 | −1.59082E+00 |
| A4 | 9.62104E−03 | 3.04435E−02 | 8.41281E−03 | 4.53071E−02 |
| A6 | 1.23350E−02 | −5.32702E−02 | −3.92368E−02 | 5.64582E−02 |
| A8 | −5.25170E−03 | 5.82529E−02 | 3.96346E−02 | −1.02946E−01 |
| A10 | −3.42289E−02 | 3.75342E−02 | 3.36957E−02 | 5.59784E−02 |
| A12 | 6.47882E−02 | −1.95030E−01 | −1.23381E−01 | 2.36880E−01 |
| A14 | −3.23997E−02 | 1.68886E−01 | 9.79723E−02 | −2.44444E−01 |

TABLE 9B

| | fifth surface | sixth surface | seventh surface | eighth surface |
|---|---|---|---|---|
| K | 2.27590E+00 | −3.15274E+00 | 0.00000E+00 | −1.16025E+01 |
| A4 | −4.49306E−02 | −1.30587E−01 | −6.79669E−02 | −9.32975E−02 |
| A6 | −2.25340E−02 | 3.63591E−02 | 1.19378E−02 | 3.42896E−02 |
| A8 | 1.75939E−02 | −2.43455E−02 | 6.05328E−03 | −1.08996E−02 |
| A10 | −1.70904E−02 | 5.56929E−03 | −2.72543E−03 | 1.97362E−03 |
| A12 | 2.08411E−02 | 4.40450E−03 | 2.88905E−04 | −1.64448E−04 |
| A14 | 0.00000E+00 | −7.74332E−04 | 0.00000E+00 | 0.00000E+00 |

The specific values of the diffractive optical element-provided surface, which is the imaging-surface-side surface of first lens 15 (second surface) in the present example are shown in Table 10.

TABLE 10

| | second surface |
|---|---|
| design wavelength | 546.07 nm |
| diffraction order | 1 |
| C2 | −1.75000E−03 |
| C4 | −1.60000E−04 |

It goes without saying that as shown in Tables 8, 9A, and 9B, in imaging lens 21 of the present example, first to fourth lenses 15 to 18 are all aspheric, but do not need to be necessarily so.

In imaging lens 21 of the present example, the diffractive optical element is formed on the imaging-surface-side surface of first lens 15 (second surface), but this is not the only option available. More specifically, the diffractive optical element-provided surface can be at least one of the following surfaces: the object-side surface of first lens 15 (first surface), the imaging-surface-side surface of first lens 15 (second surface), the object-side surface of second lens 16 (third surface), and the imaging-surface-side surface of second lens 16 (fourth surface). As a result, similar to the example of the first and second exemplary embodiments, the chromatic aberration can be well corrected by the diffracting action of the diffractive optical element-provided surface.

Table 11 shows the focal length f (mm) of the whole optical system; F-number Fno; the maximum image height Y′; the overall length of the optical system TL (mm) when parallel plate 20 is converted into an air conversion length; and the value of each of formulas (1) to (7) of imaging lens 21 of the present example.

TABLE 11

| | |
|---|---|
| f (mm) | 4.26 |
| Fno | 2.7 |
| Y′ (mm) | 2.856 |
| TL (mm) | 4.98 |
| formula (1) DS/f | 0.63 |
| formula (2) DS/Y′ | 0.94 |
| formula (3) DI/Y′ | 1.52E+00 |
| formula (4) f1/f | 0.69 |
| formula (5) f2/f | −1.13 |
| formula (6) f3/f | 0.55 |
| formula (7) f4/f | −0.59 |

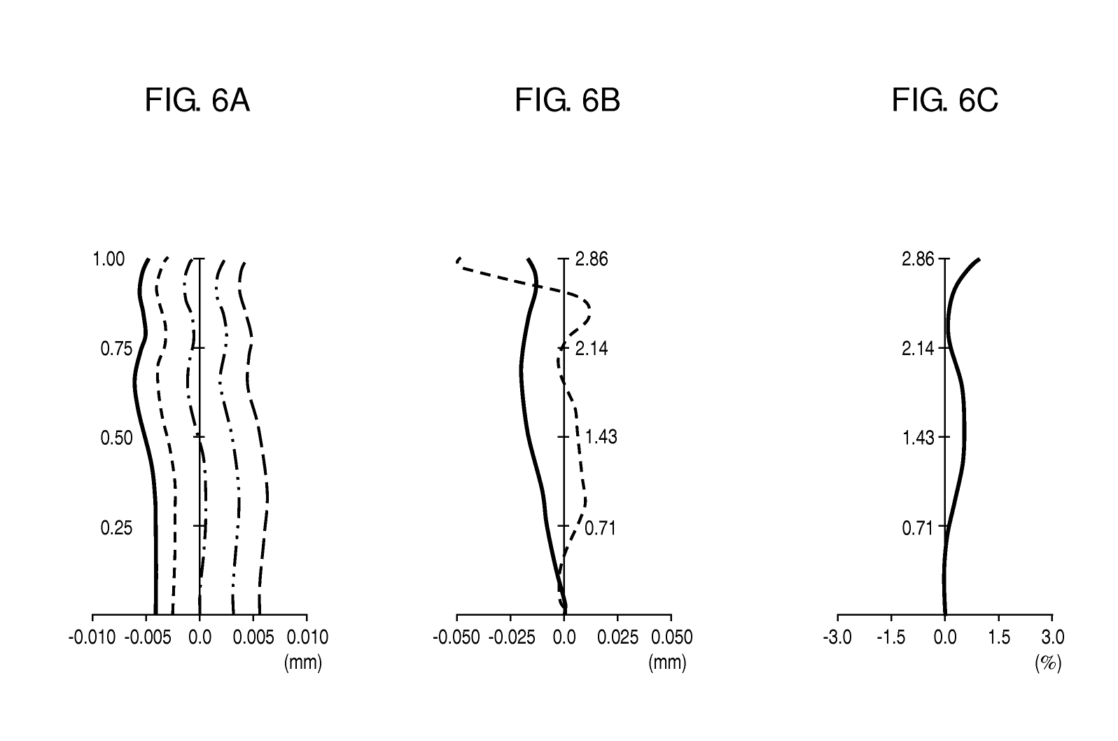

The aberrations of imaging lens 21 of the present example formed based on the above-mentioned dimensions are shown in FIGS. 6A to 6C.

FIG. 6A shows the spherical aberration (the axial chromatic aberration) of the imaging lens according to the third exemplary embodiment of the present invention. In FIG. 6A, the solid line indicates the value of spherical aberration on the g line, the long-dashed line on the C line, the short-dashed line on the F line, the two-dot chain line on the d line, and the one-dot chain line on the e line.

FIG. 6B shows the astigmatism of the imaging lens according to the present example. In FIG. 6B, the solid line indicates the sagittal image surface curvature, and the dashed line indicates the meridional image surface curvature.

FIG. 6C shows the distortion aberration of the imaging lens of the present example.

In FIG. 6C, the axial chromatic aberration is not shown because it is identical to that of FIG. 6A.

As apparent from the aberrations shown in FIGS. 6A to 6C, imaging lens 21 of the present example is well corrected for various aberrations, and can be used in image pickup device 32 with at least a megapixel resolution.

Considering the aberrations shown in FIGS. 6A to 6C and the results shown in Table 11, imaging lens 14 is made compact (reduced in size and thickness), and is also well corrected for various aberrations.

In conclusion, imaging lens 21 of the present example is of a high-performance four-lens design and can be used in image pickup device 32 with at least a megapixel resolution to be mounted on compact mobile products such as mobile phones.

In each of the exemplary embodiments, the lenses are made of glass, but may alternatively be made of other materials. For example, plastic lenses can achieve a low-cost imaging lens that is compatible with a compact high-resolution image pickup device.

As described above, the imaging lens of the present invention includes, arranged in sequence from the object side to the imaging surface side, a first lens having a positive power and convex surfaces on both sides; an aperture diaphragm; a second lens being a meniscus lens having a negative power and a convex surface on the object side; a third lens being a meniscus lens having a positive power and a concave surface on the object side; and a fourth lens having a negative power and concave surfaces on both sides.

With this structure, the imaging lens is well corrected for various aberrations such as spherical aberration, coma aberration, astigmatism, and distortion aberration in spite of being compact in the lens radial direction and thin in the optical axis direction.

In the imaging lens of the present invention, at least one surface of the first and second lenses is provided thereon with a diffractive optical element. As a result, the chromatic aberration can be well corrected by the diffracting action of the diffractive optical element.

The imaging lens of the present invention satisfies the formula (1) below:

0.3<DS/f<0.7 (1)

where DS is the distance along the optical axis from the surface of the aperture diaphragm on the object side to the surface of the fourth lens on the imaging surface side; and f is the focal length of the whole optical system.

With this structure, the imaging lens is compact in the lens radial direction and thin in the optical axis direction, and is also well corrected for various aberrations.

The imaging lens of the present invention satisfies the formula (2) below:

0.5<DS/Y′<1.4 (2)

where DS is the distance along the optical axis from the surface of the aperture diaphragm on the object side to the surface of the fourth lens on the imaging surface side; and Y′ is the maximum image height on the imaging surface.

With this structure, the imaging lens is compact in the lens radial direction and thin in the optical axis direction, and is also well corrected for various aberrations.

The imaging lens of the present invention further includes a parallel plate disposed between the fourth lens and the imaging surface, wherein the imaging lens satisfies the formula (3) below:

0.8<DI/Y′<1.8 (3)

where DI is the distance along the optical axis from the surface of the aperture diaphragm on the object side to the imaging surface when the parallel plate is converted into an air conversion length; and Y′ is the maximum image height on the imaging surface.

With this structure, the imaging lens is thin in the optical axis direction, and provides satisfactory images.

The imaging lens of the present invention satisfies the formulas (4) to (7) below:

0.5<f1/f<0.9 (4)

−1.3<f2/f<−0.7 (5)

0.4<f3/f<0.8 (6)

−1.0<f4/f<−0.4 (7)

where f is the focal length of the whole optical system; f1 is the focal length of the first lens; f2 is the focal length of the second lens; f3 is the focal length of the third lens; and f4 is the focal length of the fourth lens.

When satisfying the formulas (4) to (7) at the same time, the imaging lens is compact in the lens radial direction and thin in the optical axis direction, and is also well corrected for various aberrations.

The imaging device of the present invention includes an image pickup device for at least converting a light signal corresponding to the subject into an image signal and then outputting the image signal; and the above-described imaging lens which forms an image of the subject on the imaging surface of the image pickup device.

With this structure, the imaging device including the imaging lens can be compact and have high performance, and hence, a mobile product such as a mobile phone including the imaging device can be compact and have high performance.

### INDUSTRIAL APPLICABILITY

The present invention is useful in the field of small mobile products such as mobile phones including imaging lenses and an imaging device with these lenses. The imaging lenses and the imaging device are desired to be compatible with a compact image pickup device with at least a megapixel resolution.

### REFERENCE MARKS IN THE DRAWINGS

1, 8, 15 first lens
2, 9, 16 second lens
3, 10, 17 third lens
4, 11, 18 fourth lens
5, 12, 19 aperture diaphragm
6, 13, 20 parallel plate
7, 14, 21 imaging lens
30, 31, 32 image pickup device

1. An imaging lens comprising, arranged in sequence from an object side to an imaging surface side,
a first lens having a positive power and convex surfaces on both sides;
an aperture diaphragm;
a second lens being a meniscus lens having a negative power and a convex surface on the object side;
a third lens being a meniscus lens having a positive power and a concave surface on the object side; and
a fourth lens having a negative power and concave surfaces on both sides.

2. The imaging lens of claim 1, wherein at least one surface of the first lens and the second lens is provided thereon with a diffractive optical element.

3. The imaging lens of claim 1 satisfying a formula (1) below:
0.3<DS/f<0.7 (1)
where DS is a distance along an optical axis from a surface of the aperture diaphragm on the object side to the surface of the fourth lens on the imaging surface side; and f is a focal length of a whole optical system.

4. The imaging lens of claim 1 satisfying a formula (2) below:
0.5<DS/Y′<1.4 (2)
where DS is a distance along an optical axis from a surface of the aperture diaphragm on the object side to the surface of the fourth lens on the imaging surface side; and Y′ is a maximum image height on the imaging surface.

5. The imaging lens of claim 1, further comprising a parallel plate disposed between the fourth lens and the imaging surface,
wherein the imaging lens satisfies a formula (3) below:
0.8<DI/Y′<1.8 (3)
where DI is a distance along an optical axis from a surface of the aperture diaphragm on the object side to the imaging surface when the parallel plate is converted into an air-equivalent length; and Y′ is a maximum image height on the imaging surface.

6. The imaging lens of claim 1 satisfying formulas (4) to (7) below:
0.5<f1/f<0.9 (4)
−1.3<f2/f<−0.7 (5)
0.4<f3/f<0.8 (6)
−1.0<f4/f<−0.4 (7)
where f is a focal length of a whole optical system; f1 is a focal length of the first lens; f2 is a focal length of the second lens; f3 is a focal length of the third lens; and f4 is a focal length of the fourth lens.

7. An imaging device comprising:
an image pickup device for at least converting a light signal corresponding to a subject into an image signal and then outputting the image signal; and
the imaging lens of claim 1 for forming an image of the subject on an imaging surface of the image pickup device.

8. The imaging lens of claim 2 satisfying a formula (1) below:
0.3<DS/f<0.7 (1)
where DS is a distance along an optical axis from a surface of the aperture diaphragm on the object side to the surface of the fourth lens on the imaging surface side; and f is a focal length of a whole optical system.

9. The imaging lens of claim 2 satisfying a formula (2) below:
0.5<DS/Y′<1.4 (2)
where DS is a distance along an optical axis from a surface of the aperture diaphragm on the object side to the surface of the fourth lens on the imaging surface side; and Y′ is a maximum image height on the imaging surface.

10. The imaging lens of claim 2, further comprising a parallel plate disposed between the fourth lens and the imaging surface,
wherein the imaging lens satisfies a formula (3) below:
0.8<DI/Y′<1.8 (3)
where DI is a distance along an optical axis from a surface of the aperture diaphragm on the object side to the imaging surface when the parallel plate is converted into an air-equivalent length; and Y′ is a maximum image height on the imaging surface.

11. The imaging lens of claim 2 satisfying formulas (4) to (7) below:
0.5<f1/f<0.9 (4)
−1.3<f2/f<−0.7 (5)
0.4<f3/f<0.8 (6)
−1.0<f4/f<−0.4 (7)
where f is a focal length of a whole optical system; f1 is a focal length of the first lens; f2 is a focal length of the second lens; f3 is a focal length of the third lens; and f4 is a focal length of the fourth lens.
